(19) United States
(12) Patent Application Publication
(10) Pub. No.: US 2010/0167943 A1
(43) Pub. Date: Jul. 1, 2010

(54) System and Method for Hybridization Slide Processing

(76) Inventors: Nils Adey, Salt Lake City, UT (US); Tom Moyer, Salt Lake City, UT (US); Rob Parry, Park City, UT (US); Dale Emery, Salt Lake City, UT (US)

Correspondence Address: THORPE NORTH & WESTERN, LLP., P.O. Box 1219, SANDY, UT, 84091-1219, US

(21) Appl. No.: 12/207,343

(22) Filed: Sep. 9, 2008

Related U.S. Application Data
(60) Provisional application No. 61/060,070, filed on Jun. 9, 2008.

(51) Int. Cl. C40B 30/04; C40B 60/12

(52) U.S. Cl. 506/9; 506/39

(57) ABSTRACT

A system for the automated hybridization of a plurality of microarray slides. The system comprises an enclosure with a wash basin having an open top end, a lower carrier rotor disposed within the wash basin on a support axle for receiving a plurality of microarray slide substrates, and an upper clamp rotor disposed above the lower carrier rotor on the support axle for receiving a plurality of disposable mixers. The system is further configured so that lowering the upper clamp rotor to engage with the lower carrier rotor couples the plurality of mixers to the plurality of slide substrates to form a plurality of sealed reaction chambers, and raising the upper clamp rotor to disengage from the lower carrier rotor de-couples the plurality of mixers from the plurality of slide substrates to unseal the plurality of reaction chambers.

### RELATED APPLICATIONS

This application claims the benefit of U.S. Provisional Application Ser. No. 61/060,070, filed Jun. 9, 2008, and entitled, “System and Method for Hybridization Slide Processing,” which is incorporated by reference in its entirety herein.

### FIELD OF THE INVENTION

The field of the invention relates generally to the processing of hybridization slides for the analysis of immobilized DNA samples.

### BACKGROUND OF THE INVENTION AND RELATED ART

Micro array hybridization is a well known technique for detecting whether a specific nucleic acid resides in a given sample. This technique generally includes the immobilization of known nucleic acid sequence probes on a glass slide, followed by introduction of the sample media to the probes in order to determine whether the sample contains any complementary nucleic acid sequence. When matching sequences are found, an indicator appears to confirm the match.

While microarrays are frequently used in analysis of DNA samples, they may also be used in diagnostic testing of other types of samples. Probe locations in microarrays may be formed of various large biomolecules, such as DNA, RNA, and proteins, smaller molecules such as drugs, co-factors, signaling molecules, peptides or oligonucleotides. Cultured cells may also be grown onto microarrays. Furthermore, while it is typical to immobilize known reactants on the substrate, expose an unknown liquid sample to the immobilized reactants, and query the reaction products in order to characterize the sample, it is also possible to immobilize one or more unknown samples on the substrate and expose them to a liquid containing one or more known reactants.

Processing a hybridization slide for later analysis typically can require a significant number of process steps, including forming a reaction chamber around the portion of the slide containing the array of immobilized reactant probes, filling the reaction chamber with the mobile reactant specimens in solution, hybridizing the specimens with the probes during an incubation step, and washing off the un-hybridized fluid sample from the microarray slide upon completion of the incubation phase, without damaging the hybridized reactant samples. While attempts have been made to mechanize one or more these steps, the automation of the complete hybridization process to date has produced mixed results in terms of the quality of the exposed microarray slides, or is prohibitively expensive. Many of these steps still require extensive manual activity to ensure that high-quality hybridized microarrays are made available for later analysis.

Each processing step can also require complex and specialized processing equipment and methods. For instance, it is often desirable that reactions performed on microarrays consume minimal quantities of hybridization sample fluid, due limited specimen availability. When small quantities of hybridization fluid are spread out over the area of the microarray, however, the fluid layer is very thin, leading to the possibility that, if no mixing is provided, the sample fluid will become locally depleted of a particular sequence over the spot binding that sequence. As target specimens are depleted, reaction kinetics can slow, resulting in a lower signal. This is a greater problem for low-abundance sequences. It is considered particularly desirable that hybridization be performed in a low-volume reaction chamber, with mixing. Low volumes allow for higher concentration of reactants that are in limited supply, while mixing maintains initial kinetic rate and thus produces more reaction products.

### SUMMARY OF THE INVENTION

In accordance with the invention as embodied and broadly described herein, the present invention includes a hybridization unit for providing a hybridization reaction chamber on a microarray slide. The hybridization unit includes a microarray slide substrate having a reaction area containing immobilized reactants. The slide substrate can be substantially rectangular. A shell or “mixer” is removably coupled to the slide substrate to form a sealed low-volume reaction chamber enclosing the reaction area. The shell or mixer can be made from a plastic or polymeric material, and can be disposable. The slide substrate and the mixer are configured so that the borders of the mixer extend beyond one pair of parallel edges of the slide substrate, to allow the mixer to be coupled to an upper clamp fixture in a processing device. The slide substrate and the mixer are further configured to expose the other pair of parallel edges of the slide substrate, for coupling the slide substrate to a lower carrier fixture in the processing device.

The disposable shell or mixer can further include a manifold coupled to the exposed surface of the disposable shell having fill and vent holes aligned with the fill port and a vent port in the disposable shell.

In accordance with the invention as embodied and broadly described herein, the present invention further includes a system for the substantially automated hybridization of a plurality of microarray slides. The system comprises a basin enclosure having an open top end, a lower carrier rotor disposed on a support axle within the basin enclosure for receiving a plurality of microarray slide substrates, and an upper clamp rotor disposed on the support axle and above the lower carrier rotor for receiving a plurality of disposable shells or mixers. The system is configured so that lowering the clamp rotor to engage with the carrier rotor couples the plurality of mixers to the plurality of slide substrates to form a plurality of sealed reaction chambers. The system is further configured so that raising the upper clamp rotor to disengage from the lower carrier rotor de-couples the plurality of mixers from the plurality of slide substrates to unseal the plurality of reaction chambers.

The present invention also includes a method for processing a plurality of microarray slides, which method comprises the steps of inserting a plurality of microarray slides into a processing device, where each of the microarray slides has a reaction area covered by a low-volume reaction chamber shell or mixer. The method continues with filling the reaction chambers shells with a low-volume of hybridization fluid to hybridizing the reaction area of each of the microarray slides. The method further includes the steps of removing the reaction chamber shells from each of the microarray slides to expose the hybridized reaction areas, washing the microarray slides in a common bath of wash fluid, removing the wash fluid from the microarray slides, and disengaging the microarray slides from the processing device.

The present invention also includes a method for the in-situ processing of a microarray slide for the analysis of immobilized samples. The method includes the steps of obtaining a slide substrate having a reaction area containing immobilized samples and mounting the slide substrate into a processing device for automated in-situ processing. The in-situ processing further comprises the steps of coupling a disposable shell or mixer to the slide substrate to form a low-volume reaction chamber enclosing the reaction area, filling the reaction chamber with hybridization fluid to react with the immobilized samples, sealing the reaction chamber to prevent contamination during incubation, de-coupling the mixer from the slide substrate to open the low-volume reaction chamber and expose the reaction area, flushing the reaction area with a high volume of wash fluid to remove the hybridization fluid, and removing the wash fluid from the slide substrate.

Other aspects of the method of the present invention can include agitating the hybridization fluid within the reaction chamber to increase the reaction with the immobilized samples on the microarray slide, and sealing the reaction chamber by removably plugging the fill and vent holes in the mixer/manifold assembly with a plurality of valve pins.

The present invention also includes a method for post-processing the hybridized slide that has been flushed with wash fluid to remove the hybridization fluid. The method can includes the steps of re-attaching the disposable shell or mixer to the slide substrate to re-form the low-volume reaction chamber enclosing the hybridized reaction area, and performing a variety of fluidic steps such as nucleic acid denaturation and recovery on the hybridized and washed microarray slides.

In another aspect of the invention, instead of de-coupling the mixer from the slide substrate and flushing the reaction area with a high volume of wash liquid, an elution buffer is slowly pumped into the reaction chambers to wash the reaction areas and displace the original sample of hybridization fluid, which is pushed out and collected with an appropriate collection device positioned below the slide substrate. The reaction chamber is then re-sealed and re-heated for a second processing step, after which additional elution buffer is pumped through the reaction chambers to force the reacted fluid into another collection device for additional analysis.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 illustrates a top view of a hybridization unit, according to an exemplary embodiment of the present invention;

FIG. 2 illustrates a sectional side view of the hybridization unit of FIG. 1, taken along section line A-A;

FIG. 3 illustrates a perspective view of the hybridization system, according to an exemplary embodiment of the present invention;

FIG. 4 illustrates a top view of the hybridization system of FIG. 3;

FIG. 5 illustrates a sectional side view of the hybridization system of FIG. 3;

FIG. 6 illustrates an exploded view of the hybridization system of FIG. 3;

FIG. 7 illustrates a sectional side view of the rotors in an engaged position;

FIG. 8 illustrates a sectional end view of the rotors in an engaged position;

FIG. 9 illustrates a sectional side view of the rotors after lifting the upper rotor to separate the mixer and the slide substrate;

FIG. 10 illustrates a sectional end view of the rotors after lifting the upper rotor to separate the mixer and the slide substrate;

FIG. 11 illustrates a sectional side view of the rotors in the wash position;

FIG. 12 illustrates a sectional end view of the rotors in the wash position;

FIG. 13 illustrates a perspective view of a hybridization system, according to another exemplary embodiment of the present invention;

FIG. 14 illustrates an exploded view of the hybridization system of FIG. 13;

FIG. 15 illustrates an exploded, perspective view of a hybridization system, according to yet another exemplary embodiment of the present invention; and

FIG. 16 illustrates a detailed view of one aspect of the hybridization system of FIG. 15.

### DETAILED DESCRIPTION OF EXEMPLARY EMBODIMENTS

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

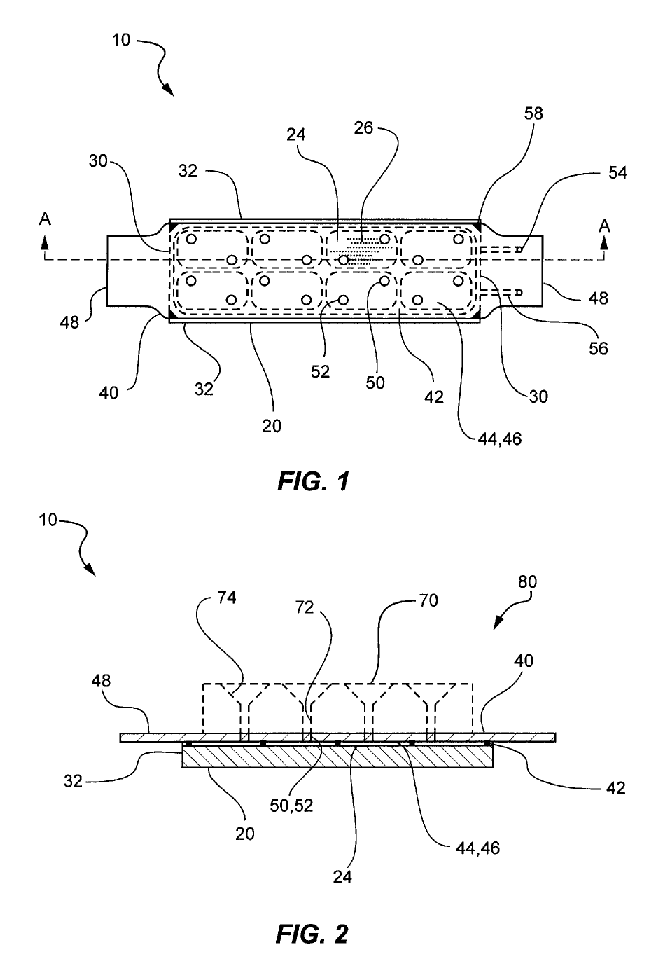

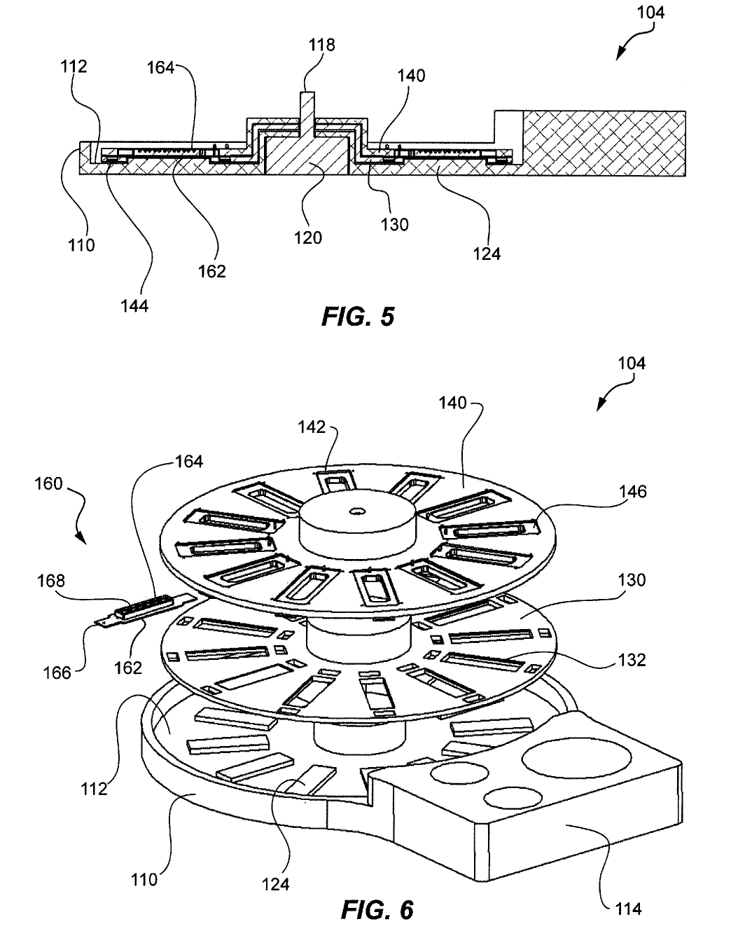

It has been recognized by the present inventors that it would be advantageous to follow the hybridization step of the hybridization process with a wash step that is much higher in fluid volume than the fluid volume used in hybridization. Illustrated in FIGS. 1-16 are various exemplary embodiments of a system and method for automated hybridization slide processing that include a low-volume hybridization step followed by a high-volume wash step.

Each of the exemplary embodiments of the hybridization system can include a hybridization unit 10, which is shown with more particularity in FIGS. 1 and 2. The hybridization unit 10 can comprise a substantially rectangular glass slide substrate 20 having a reaction area 24 that contains immobilized reactants 26, such as immobilized DNA samples. The reaction area can be covered by a disposable shell, or mixer 40, that is removably coupled to the slide substrate 20 to form a low-volume reaction chamber 44 that encloses the reaction area 24. The mixer can be attached to the slide substrate with a mixer seal 42, which can be a removable adhesive, an elastomeric seal (such as an O-ring or a gasket, including a silicone gasket) or any other sealing mechanism available in the art to form a sealed reaction chamber sufficient to hold and contain the hybridization fluid during the filling and incubation stages of the process. If a non-adhesive or elastomeric seal 42 is used, small amounts of corner adhesive 58 can be positioned on the corners of the slide to lightly couple the mixer 40 to the slide substrate 20 until the hybridization unit 10 is placed into a processing device, as discussed in more detail below. The reaction chamber 44 can be provided with a fill port 50 and a vent port 52 to allow for the introduction of hybridization fluid and the venting of enclosed air or gases.

Typically, the reaction area 24 containing the immobilized reactants 26 can substantially cover the top surface of the slide substrate 20, leaving room for the mixer seal 42 around the periphery of the microarray slide to define the outer boundaries of the reaction chamber 44. A single reaction chamber can cover the entire reaction area on the face of the slide. It is also possible, however, for the immobilized reactants to be grouped into different sections and the reaction chamber 44 to be subdivided into a plurality of individually sealed sub-chambers 46, with each sub-chamber being isolated from the adjacent sub-chambers by seal segments extending across the face of the slide. For example, the exemplary reaction chamber illustrated in FIGS. 1-2 is subdivided into eight sub-chambers 46, with each sub-chamber having its own fill 50 and vent 52 ports. In other aspects of the present invention the number of sub-chambers can include, but is not limited to, two, four, six or twelve sub-chambers, as the needs arises.

The height of the reaction chamber(s) 44, 46, as defined by the distance between the top of the slide substrate 20 and the bottom of the mixer 40 (or the thickness of the mixer seal) can be controlled to about 1/1000 inch (or 25 μm), although a greater height is often used. Controlling the height of the reaction chamber to about 1/1000 inch allows the volume of the chamber, and hence the volume of required hybridization fluid, to be limited to about 25 μl or less. It is to be appreciated, however, that the volume of a reaction chamber can vary from about 5 μl for a smaller sub-chamber 46 up to about 100 μl for a larger, single reaction chamber 44. This range can be considered by one having skill in the art as providing low-volume hybridization, which allows for a higher concentration of the specimens suspended in the hybridization fluid to be brought into contact with the immobilized probes on the slide 20.

The mixer 40 can be made from a multi-layer, flexible polymer material to form a transparent laminate structure, providing the user with the ability to see the progress of the hybridization fluid as it fills the reaction chamber(s) 44, 46 and forces the current volume of air out of the vent hole(s) 52. The mixer can also be provided with an integrated agitation system such as air bladders (not shown), that can be formed into a ceiling portion of the mixer, and which can operate to extend the ceiling portion downward into the reaction chamber(s) upon inflation. The air bladders can be pneumatically inflated and deflated to continuously mix the hybridization fluid inside the reaction chamber during incubation. Pneumatic ports 54 and lines 56 which connect the air bladders with the hybridization system can formed into one end tab 48, preferably an interior end tab, of the mixer. The mixer's pneumatic agitation system is described in more detail in U.S. Pat. No. 7,234,400, filed Aug. 2, 2002 and titled “Laminated Microarray Interface Device,” which reference is incorporated in its entirely herein.

The mixer 40 can be coupled with an optional manifold device 70 that facilitates the filling and sealing of the reaction chamber 44 or sub-chambers 46 and reduces the risk of cross-contamination of samples. The manifold can include a series of inlet holes and vent passages 72 which align with the inlet 50 and vent ports 52 in the mixer, respectively. The inlet/vent holes 72 can be formed with funnel-shaped openings 74 to capture and direct the tip of a pipette into the inlet/vent hole, and guide the hybridization fluid into the reaction chamber or sub-chambers. After filling and venting, the inlet 50 and vent 52 ports in the mixer 20 can be closed in a variety of means, including insertable plugs, a slidable seal bar integrated into the manifold, or a piercable septum layer integrated into mixer itself, etc., so that the reaction chamber(s) 44, 46 becomes a fluid-tight enclosure that is protected from outside contamination during the incubation stage of the hybridization process. Furthermore, the manifold 70, the mixer 40 and the mixer seal 42 can be configured as a mixer/manifold sub-assembly 80. Both the mixer 40 and the mixer/manifold sub-assembly can be disposable and configured for easy coupling and de-coupling with the top surface of the slide substrate 20.

The hybridization unit 10 can also be configured so that the borders of the mixer 40 extend beyond one pair of parallel edges 30 of the slide substrate and expose the other pair of parallel edges 32. In the exemplary embodiment shown in FIGS. 1-2, the mixer extends further along the long axis (beyond the short edges) of the slide substrate to provide a pair end tabs 48 at both ends 30 of the hybridization unit. At the same time, the mixer 40 can be narrower than the width of the slide substrate 20, and exposes the pair of edges 32 bordering the length of the slide substrate. In another aspect of the present invention the sets of parallel edges can be switched, with the flaps of the mixer covering and extending beyond the long edges of slide substrate, and the short edges at either end of the slide substrate remaining exposed.

As will be discussed in more detail hereinafter, this configuration allows for the mixer 40 to be coupled to an upper clamp fixture of a processing device, and for the slide substrate 20 to be coupled to a lower carrier fixture of the processing device. After receiving the mixer and the slide substrate, the upper and lower fixtures can be engaged together, coupling the mixer and the slide substrate to form the reaction chamber(s) 44, 46. Subsequent disengagement of the upper and lower fixtures operates to de-couple the mixer from the slide substrate, unsealing and breaking open the reaction chamber(s) 44, 46.

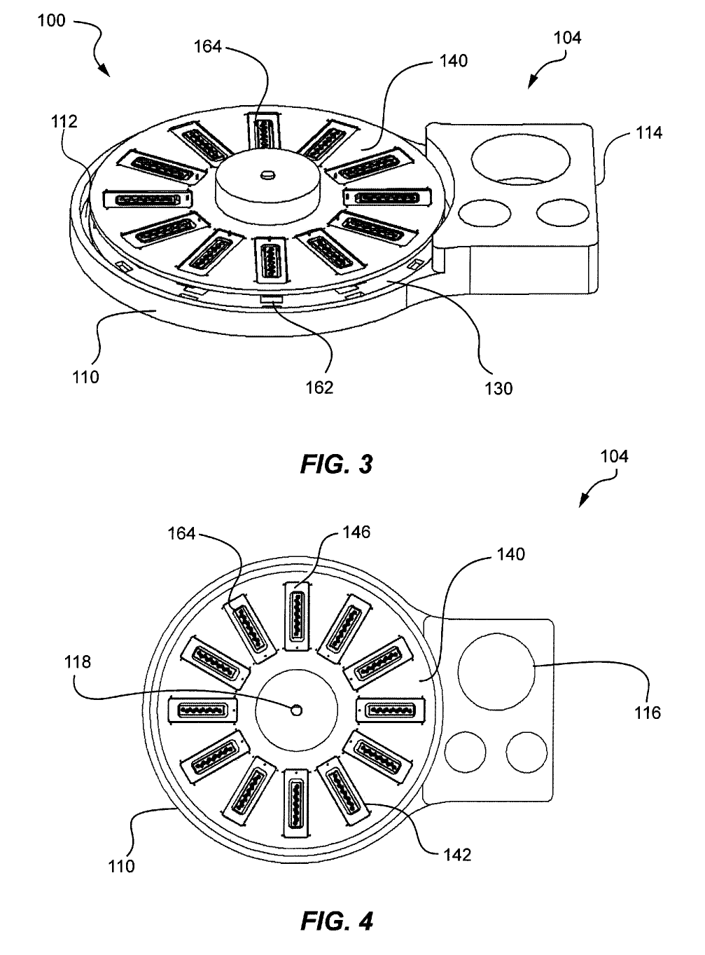

A processing device 104, which together with the hybridization unit 160 forms an exemplary embodiment 100 of the present invention for the substantially automated hybridization of a plurality of microarray slides, is generally illustrated in FIGS. 3-6. The processing device 104 can include a basin enclosure 110 having an open top end. The basin enclosure can include a basin 112 that is configured to hold a quantity of wash fluid for washing the microarray slides after completion of the hybridization process. The basin 112 can be circular, as illustrated, or can have any other shape or configuration capable of temporarily holding or containing a quantity of wash fluid sufficient to immerse or submerge the plurality of microarray slides, which range can include, but is not limited to, 0.1 to 3.0 liters of wash fluid. The basin enclosure 110 can further include a side section 114 having recesses 116 for holding wash fluid bottles, as well as internal plumbing such as valves and pipes for filling and draining the wash fluid from the basin.

The processing device 104 can include a slide carrier disposed within the basin enclosure 110, and configured to receive a plurality of microarray slide substrates 162. The slide carrier can be a lower carrier rotor 130 supported on a support axle 118 and driven by a spin motor 120, as shown in the illustrated embodiment, that allows rotational movement of the lower carrier rotor (including the received slide substrates) relative to the basin 112 and the wash fluid held therein. Furthermore, the lower carrier rotor 130 and the basin enclosure 110 can be configured together for immersing the lower carrier rotor within a bath of wash fluid contained within the basin 112, followed by removing the lower carrier rotor from the bath and stripping off any residual wash fluid. Removing the lower carrier rotor from the bath can be accomplished by lifting the lower carrier rotor out of the bath, or by draining the wash fluid out of the basin enclosure. In one aspect of the invention, the lower carrier rotor 130 can be both raised away from the floor of the basin 112 and rotated about the support axle 118 while the wash fluid is drained.

The processing device 104 can further include a clamp plate disposed above the slide carrier, and configured to receive a plurality of mixer/manifolds 164 or individual mixers 166. The clamp plate can be an upper clamp rotor 140 supported on the same support axle 118 and above the lower carrier rotor 130, as shown in the FIGS. 3-6. The support axle 118 can be segmented to allow for differential rotational movement of the upper clamp rotor 140 relative to both the basin enclosure 110 and to the lower carrier rotor 130. The upper clamp rotor can also be configured for immersion and rotation within the bath of wash fluid contained within the basin 112.

In the rotating embodiment of FIGS. 3-6, the upper clamp rotor 140 and lower carrier rotor 130 can be configured for engagement one with the other by providing for relative vertical movement between the two discs. When engaged, the plurality of mixer/manifolds 164 previously received by the upper clamp rotor 140 can couple to the plurality of slide substrates 162 previously received on the lower carrier rotor 130, to form a plurality of a hybridization units 160 with sealed hybridization reaction chambers. And when disengaged, the separating motion between the upper clamp rotor and the lower carrier rotor causes the mixer/manifolds 164 to de-couple from the slide substrates 162, pulling the mixers off the slide substrates and breaking open each of the mixer seals that form the plurality of reaction chambers.

The mixer/manifolds 164 coupled to the upper clamp rotor 140 can be angularly aligned with the slide substrates 162 coupled to the lower carrier rotor 130 before the two rotors are brought together. This can be accomplished by monitoring and controlling the angular position of both rotors until the mixer/manifolds and slide substrates align.

The slide substrates 162 can be inserted into equally-spaced carrier rotor ‘windows’ 132 formed into the lower carrier rotor 130. The carrier rotor windows 132 can have slots or grooves formed in the interior side surfaces for receiving and grasping the exposed edges of the slide substrates not covered the mixer, and flexible tabs at the ends of the slots that flex open during installation and snap closed afterwards to prevent the slide substrate 162 from being flung out of window 132 during rotation, especially during high-speed spinning of the lower carrier rotor 130.

The mixer/manifolds 164 can attach to the upper clamp rotor 140 via the end tabs of the mixer 166 extending lengthwise beyond the edges of the slide substrate (see FIG. 6). The end tabs can be grasped by clips or tabs formed at both ends of a clamp rotor ‘window’ 142 that extend downwards towards the lower carrier rotor. The clips may function not only as connection points with the end tabs, but to also serve as interlocking alignment and engagement features that better align and secure the two rotors together.

The upper clamp rotor can be configured to receive both individual mixers 166 or mixer/manifold sub-assemblies 168, in which the manifold can be coupled to the mixer prior to loading into the clamp rotor to facilitate the subsequent filling, venting and sealing of the reaction chambers or sub-chambers.

In one aspect of the present invention the clamp rotor window can be equipped with a flexible “floating lid” 146 secured about the inner edge of the clamp rotor window 144 that spans the gap between the inner edge of the window and the manifold 168. When the two rotors are separated, the floating lid can operate to snuggly fit around and grasp the manifold, to further secure the mixer/manifold 164 to the clamping plate rotor. And when the upper clamp rotor 140 is engaged with lower carrier rotor 130, with or without the manifold, the floating lid 146 can function as a planar spring that presses down on the top surface of the mixer 166 to fully compress the mixer seal and create the fluid-tight reaction chamber. Using the spring-like floating lid to press against the top surface of the mixer provides for greater tolerances when engaging the upper and lower rotors, and avoids the application of excessive force by the clamping plate rotor that might cause a slide substrate 162 to crack or break.

In another aspect of the present invention the manifolds 168 may be permanently attached to the upper clamp rotor 140, with only the mixers 166 being removable and disposable with each cycle of the hybridization process. Furthermore, the manifolds can be configured with a universal pattern of filler funnels and vent passages to accommodate the various sub-chamber configurations available with the mixer shells.

In yet another aspect of the present invention, the mixer/manifolds 164 or mixers 166 can be coupled to the slide substrates 162 prior to mounting of the slides into the lower carrier rotor 130. After receiving the pre-assembled hybridization units 160, the clamp rotor 140 can be lowered to engage the carrier rotor and to apply the necessary pressure to the top of the mixer 166 to properly seal the reaction chambers. The clamp rotor can also automatically attach to the end tabs of the mixer, so that subsequent lifting of the clamp rotor breaks the mixer seal and removes the mixer 166 or mixer/manifold 164 from off the slide substrate 162, as described above.

Air lines for connection with the pneumatic lines in the mixer can be formed in or attached to the upper clamp rotor. The air lines can terminate in exit holes with elastomeric seals that align with the pneumatic ports in the mixer. Pressing the upper clamp rotor against the top surface of the mixer, to create the fluid-tight reaction chamber between the mixer and the slide substrate, simultaneously creates an air-tight seal between the air line terminations and the pneumatic ports in the end tab of the mixer.

Additional aspects of the hybridization system can include slide heaters 124 which extend upwards from the floor of the basin 112 and into the bottom of the slide carrier windows 132 when the slide carrier is lowered to the bottom of the basin enclosure 110, typically during the reaction or incubation phase of the hybridization process. The slide heaters 124 can align adjacent to or press against the bottom surface of the slide substrate 162, and can provide heat to the hybridization fluid that further excites the suspended reactants into motion and increases the efficiency of the reaction. In one aspect of the present invention, the slide heaters can heat the slide substrate 162 up to a temperature of about 95° C.

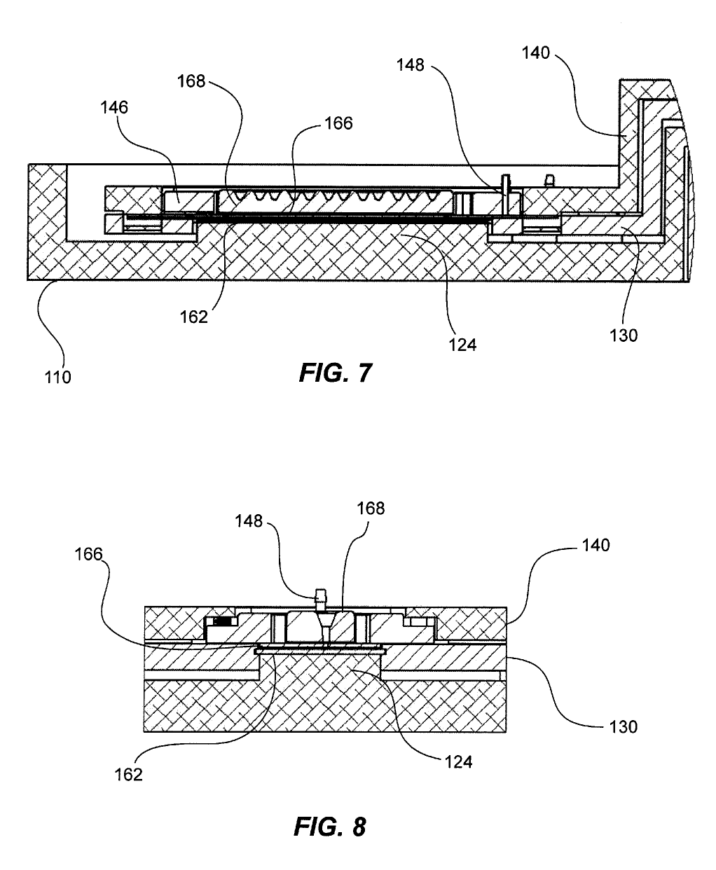

Illustrated in FIGS. 7 and 8 are sectional side and end views of the upper clamp rotor 140 and the lower carrier rotor 130 in a closed position, as can occur during the filling and incubation stages of the hybridization process. In this position, the joined rotors can be positioned at the bottom of the basin enclosure 110, with the heaters 124 projecting upwards into the carrier rotor window and contacting the bottom of the slide substrate 162. The upper clamp rotor can bear down on the outer edges of the top surface of the mixer 166 with the floating lid 146, forcing the mixer seal firmly against the top surface of the slide substrate 162 to form the reaction chambers with fluid-tight seals. A manifold 168 can be coupled to an interior portion of the top surface of the mixer and aligned with the inlet and vent ports. Furthermore, the air lines 148 in the upper clamp rotor can be placed in pneumatic communication with the pneumatic ports in the mixer, allowing operation of the mixer air bladders to agitate and mix the hybridization fluid during incubation.

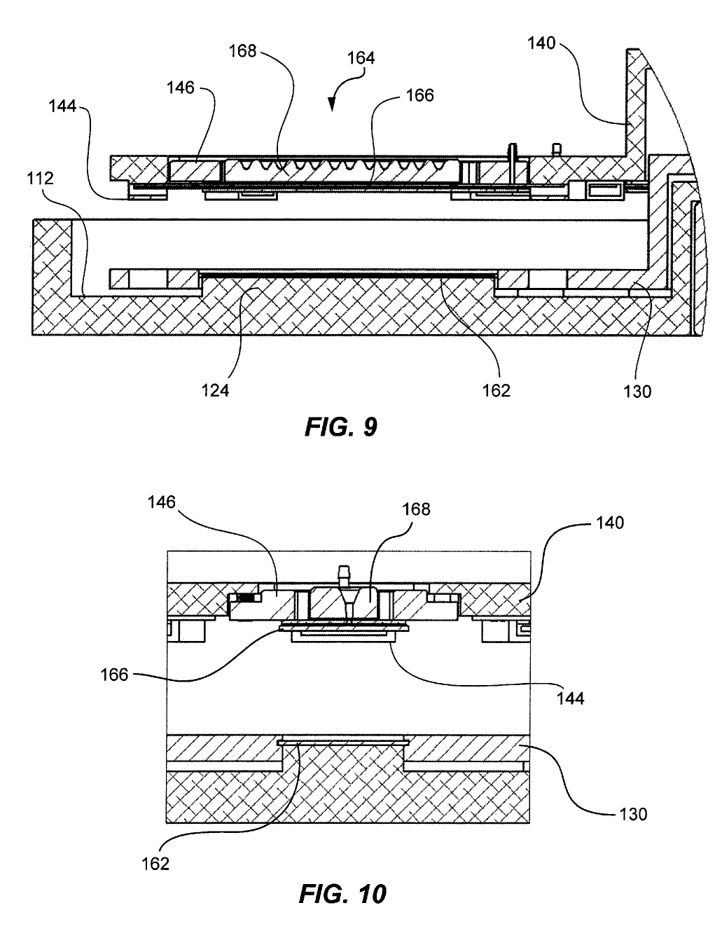

Illustrated in FIGS. 9 and 10 are sectional side and end views of the upper clamp rotor 140 and the lower carrier rotor 130, and after the upper clamp rotor has been lifted away from the lower carrier rotor to separate the mixer/manifold 166 and the slide substrate 162, upon completion of the incubation stage. The lifting movement of the upper clamp rotor can break open mixer seal forming the reaction chambers and pull the mixer off the slide substrate, leaving the top surface of the slide substrate exposed for washing. The basin 112 can be filled with wash fluid to completely immerse the two rotors before the upper rotor is lifted away and the mixer de-coupled from the slide substrate. Breaking the mixer seal with the slide substrate submerged can allow for the reaction area on top of the slide substrate to be immediately flushed with wash fluid upon the opening of the reaction chamber, to minimize the possibility of cross-contamination of the contents of any reaction chamber onto a neighboring array.

During the washing process the basin enclosure can be alternately drained and filled with various wash fluids to completely strip away the hybridization fluid. At this stage in the hybridization process the upper rotor 140 can be lifted out and above the basin enclosure and separately spun at a high speed to throw off any residual wash liquid that could drip down and contaminate the slide substrates during the subsequent drying or wash water removal stage. In one aspect of the present invention the upper clamp rotor, with its attached mixers and manifolds, can be completely removed from the processing device for cleaning and removal of the mixer/manifolds 164 before the washing of the lower carrier rotor is completed.

Further illustrated in FIGS. 9 and 10 are the clamp rotor clips or tabs 144 which can extend downwards from the clamp rotor and attach to the end tabs of the mixer 166, and which can operate to pull the mixer off the slide substrate 162 and break apart the hybridization unit 160 when the upper clamp rotor 140 is lifted away lower carrier rotor 130. Also shown is the floating lid 146 that can press down on the top surface of the mixer 166 to fully compress the mixer seal and create a hybridization unit with a fluid-tight reaction chamber when the two rotors are coupled together, and which can also grasp the manifold 168 and further secure the mixer/manifold 164 to the clamping plate rotor 140 during the separation of the two disc rotors.

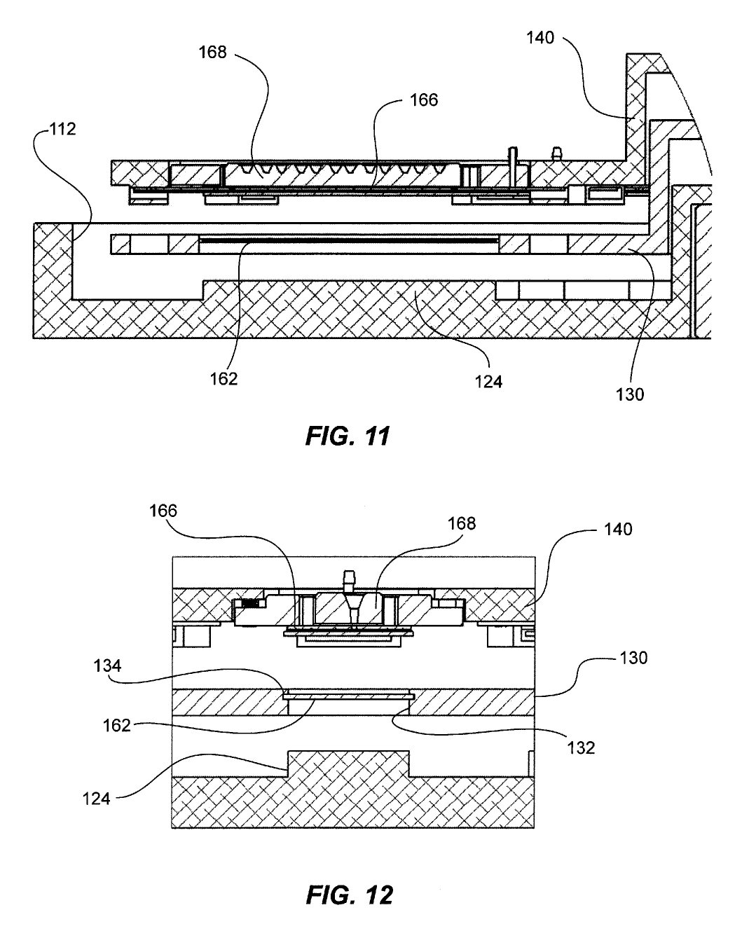

As illustrated in FIGS. 11 and 12, the lower carrier rotor 130 can also be lifted off the projecting slide heaters 124 and partially away from the bottom of the basin 112, so as to allow the disc to rotate around its supporting axle during the washing stage and create a relative motion or current flowing over and around the slide substrate 162. This can provide for a faster and more thorough cleaning of both the reaction area and bottom surfaces of the slide substrate. Moreover, the rate of rotation can be moderated to avoid damaging the hybridized immobilized reactant probes.

In another aspect of the invention, the joined rotors 130, 140 can both be lifted off the projecting slide heaters 123 and rotated together while the basin 112 is filled with sufficient wash fluid to submerge the rotating rotors, prior to separating the discs. This ensures that a degree of fluid sheer is present at the de-coupling of the mixers 166 or mixer/manifolds 164 from the slide substrates 162, to quickly sweep away the hybridization fluid on the slide and reduce the risk of cross-contamination. This can be especially advantageous for microarray slides having multiple sub-chambers, which when opened may allow for undesirable intermixing of the various hybridization samples unless all of the fluids are quickly removed. Inducing a flow of wash liquid over the surface of the slide through rotation of the rotor discs can minimize the risk of cross-contamination.

The hybridization system 100 of the present invention is advantageous over the prior art by providing for a reaction stage that uses very low-volume reaction chambers followed by a high-volume wash stage. As disclosed above, this can be accomplished by temporarily forming sealed, low-volume reaction chambers on the surface of the slide, which seals can be broken and the reaction chambers opened to expose the slide to a high volume flush or bath of wash fluid. It has been recognized that the benefits of a high-volume wash cannot be realized by forcing wash fluid through the low-volume reaction chamber utilized during the incubation cycle. It has been further recognized that removing the reaction chamber and exposing the slide to a high volume flush or bath of wash fluid can remove the used hybridization fluid from off the slide more completely and at a faster rate.

It is further recognized that the high volume flush or bath of wash fluid can be common to each of the plurality of microarray slides. Immersing and moving a number of slide substrates through the same bath of cleaning fluid provides for the simultaneous cleaning of multiple slides and for the efficient and economical use of wash fluids. Using a high volume wash, moreover, can also reduce the chance of cross-contamination, as the micro-liter size of the hybridization fluid samples can be thoroughly swept away and diluted within the much larger liter-sized quantity of wash fluid.

Further illustrated in FIGS. 11 and 12 are the slide coupling grooves or slots 134, which can be formed in the carrier rotor window 132 for receiving and grasping the exposed edges of the slide substrates that are not covered by the mixer.

Referring back to the rotating embodiment illustrated in FIGS. 3-12, the wash stage can include the use of multiple wash fluids, during which process the basin 112 in the basin enclosure 110 can be alternately drained and filled, and during which the lower carrier rotor 130 and attached slide substrates 162 are continuously rotated. After the wash stage is complete, the basin enclosure can be drained of all fluids and the lower carrier rotor spun at a higher rotational speed to throw off any residual wash fluids through centripetal action. In another aspect of the invention, the upper clamp rotor 140, positioned directly above the lower carrier rotor, can be provided with downwardly directed nozzles that provide jets of nitrogen gas, or humidified or ozone-free air to blow any residual wash fluids off the surfaces of the slide before they can dry and spot the hybridized reaction area.

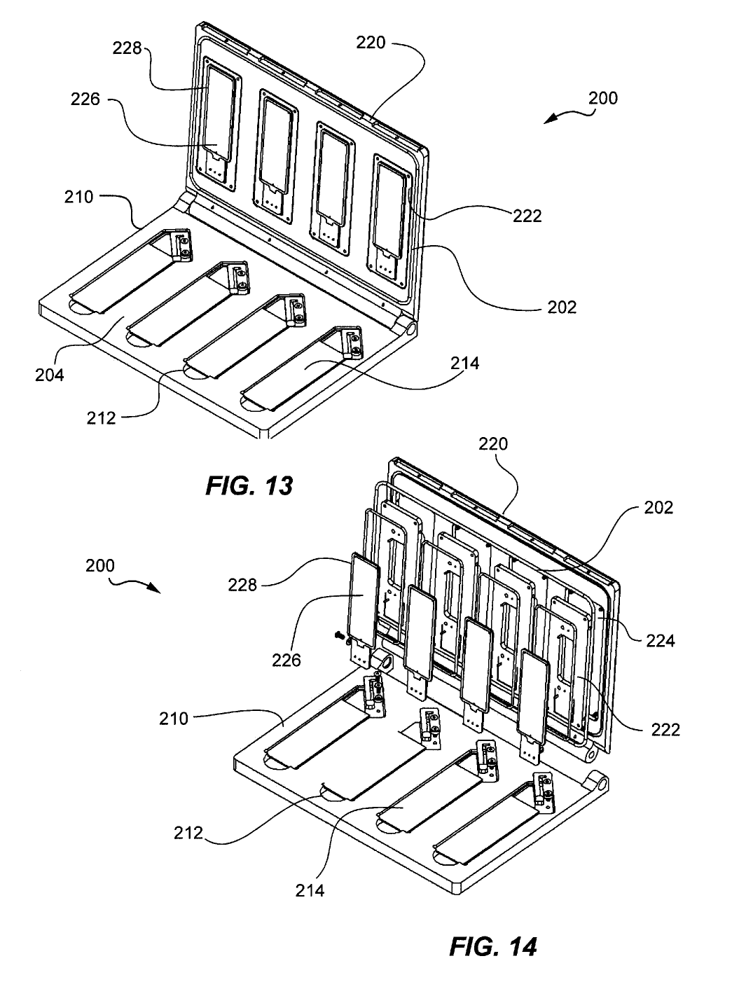

Another exemplary embodiment 200 of the present invention that uses non-rotating components is illustrated generally in FIGS. 13 and 14. The embodiment can include a basin enclosure 210 having an open top end. The basin enclosure can be configured to hold a quantity of wash fluid sufficient to immerse or submerge a plurality of microarray slides after completion of the incubation state of the hybridization process. The basin enclosure can be rectangular, and can further include a side section (not shown) having recesses for holding wash fluid bottles, as well as internal plumbing such as valves and pipes for filling and draining the wash fluid from the basin enclosure. The internal plumbing can be configured for rapid draining and filling to reduce the time during which the slides are not submerged.

The processing device can include a lower carrier plate or fixture 212 disposed within the basin enclosure and configured to receive a plurality of microarray slide substrates 214. In the embodiment shown, the lower fixture 212 can be formed into the bottom surface of the basin enclosure 210. The processing device can also include a upper clamp plate or fixture 222 disposed above the lower plate, and configured to receive a plurality of disposable mixers 226. The upper clamp fixture can be common to all the mixers, or the processing device can be configured with individual clamp fixtures for each mixer, as shown.

In the non-rotating embodiment of FIGS. 13 and 14, the clamp fixture(s) 222 can be associated with the top cover 220 of the processing device, and can be configured with a piston-like actuator 224 to provide for relative motion and engagement between the upper fixture(s)222 and the lower fixture 212. When engaged, the plurality of mixers 226 with mixer seals 228 previously received by the clamp plate can couple to the plurality of slide substrates 214 previously received on the carrier plate 212, to form a plurality of sealed hybridization reaction chambers. And when disengaged, the separating motion between the upper clamp fixture and the lower carrier fixture causes the plurality of mixers to de-couple from the plurality of slide substrates, pulling the mixer seals off the slide substrates and breaking open each of the plurality of reaction chambers.

The top cover 220 can coupled to the basin enclosure 210 and seal with an outer wash chamber seal 202 to form an outer chamber 204 that completely surrounds and encloses the plurality of hybridization units. Once the cover is secured over the basin, the piston-like actuators 224 can activate to close the gap between the mixers 226 and the slide substrates 212 to form the individually-sealed hybridization reaction chambers, and withdraw to remove the mixers from the slide substrates after incubation is complete.

Flushing and washing the hybridized slide substrates after completion of the incubation stage can be accomplished by flowing wash fluids through the enclosed outer wash chamber 204 that is common to all of the microarray slides installed into the processing device. The wash fluid can be caused to move or flow relative to the received slide substrates 212 with a liquid pump or similar device. Removal of the wash fluids after the wash cycle is complete can be accomplished by draining the wash fluids out of the wash chamber and providing downwardly directed jets of nitrogen gas or humidified or ozone-free air onto the tops of the slide substrate to remove any residual wash fluids.

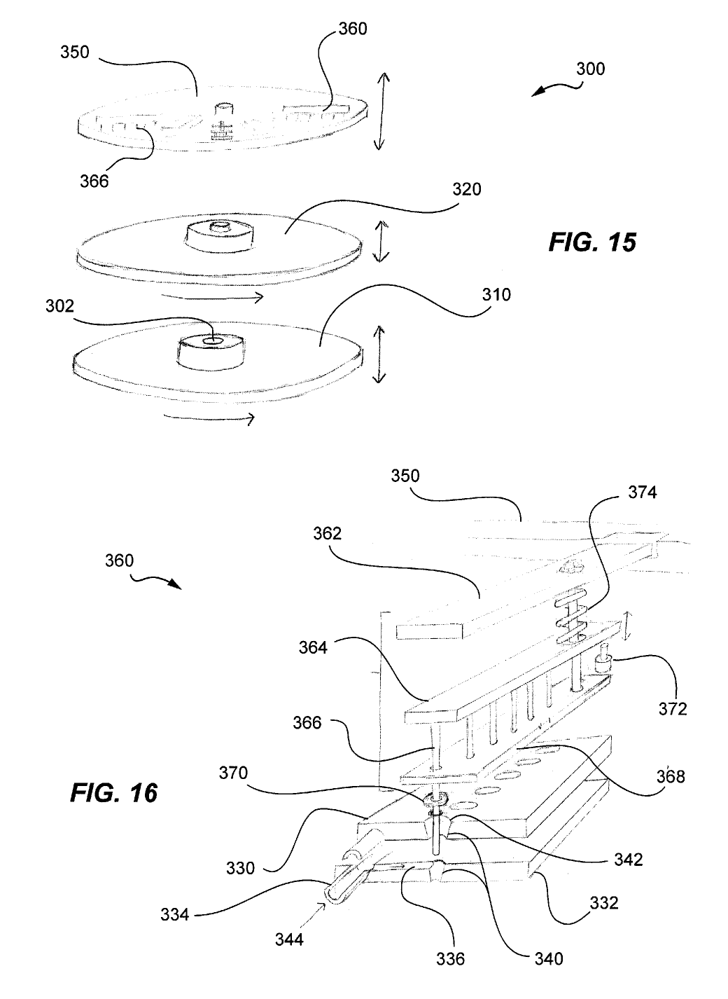

Illustrated in FIG. 15 is yet another embodiment 300 of the hybridization system of the present invention, which embodiment employs three disc plates or rotors. The lower rotating discs can comprise a lower carrier rotor 310 and an upper clamp rotor 320, which both move up and down and rotate about the support axle 302. The embodiment shown in FIG. 15 can also include a third top valve disc 350. The valve disc can be configured for movement in the axial direction (up and down), and may or may not rotate with the lower disc rotors.

The top valve disc 350 can be configured with a plurality of valve stations 360 configured for interconnection with the plurality of manifolds/mixers mounted on the clamp rotor below. Extending outwardly, or downwardly from the bottom, of each valve station 360 can be a set of valve pins 366 that can be inserted into a series of inlet/vent holes 340 formed in the manifold (similar to the holes 72 and funnels 74 in the manifold illustrated in FIG. 2). The valve pins can be solid, and can be formed from a hardened or stainless metallic material. The valve pins can be used to control the flow of fluid both into and out of the reaction chamber(s), and to act as plugs to seal the reaction chamber(s) during the incubation stage. Although described in conjunction with an embodiment 300 of the hybridization system using a rotating processing device, the valve station can also be configured to work with the non-rotating processing device.

One embodiment of the valve station 360 is shown in more detail in FIG. 16. The valve station can include a plurality of plates, including a top plate 362 providing a fixed base of movement, a valve pin activation plate 364, and an O-ring retaining plate 368 for guiding and maintaining the valve pins 366 in the proper position and orientation. The actuation plate 364 can be biased in the downward direction with a spring 374, but its vertical position can be controlled by an air-powered (pneumatic) piston 372 or similar actuation device. An O-ring 370 concentric with each valve pin 366 creates a seal between the valve pin and the funnel-shaped openings 342 in the manifold when the valve station 360 is coupled to the mixer/manifold below.

The valve pins 366 can interconnect with the inlet/vent holes 340 in the manifold and seal the holes during hybridization. The inlet/vent holes in the manifold can be provided with funnel-shaped openings 342 for receiving and guiding the valve pins 366 into the inlet/vent holes. In one aspect of the invention the manifold can be separated into an upper manifold 330 and lower manifold 332, and internal fluid passages can be formed therein. For example, the manifold can have a main fluid line 334 connecting to a plurality of transfer fluid lines 336, which can intersect with the inlet/vent holes 340 at the split line between the upper manifold 330 and lower manifold 332. In one aspect of the invention, the valves pins 366 can be partially withdrawn to allow fluid 344 from the main line 334 to flow down through the inlet ports 340 and into the reaction chambers. Likewise, the valve pins can be partially removed to allow reversible flow of displaced fluid out of the vent passages, through the fluid passages and into an appropriate collection device (not shown).

The method of the present invention utilizing the valve disc 350 can include mounting the slide substrates into the lower carrier rotor 310 and the mixer/manifolds into the upper clamp rotor 320, and lowering the clamp rotor to engage the carrier rotor and couple the mixer/manifolds to the slide substrates to form reaction chambers. The reaction chambers can then be filled with hybridization fluid through the funnel-shaped openings 342 in the manifold. After filling, the valve disc 350 with downwardly projecting valve pins 366 can be lowered into the inlet/vent ports 340 of the manifold to seal the reaction chambers. Hybridization can then take place, with mixing during the incubation stage controlled with pressurized air delivered to the bladders formed in the mixers.

After hybridization is complete, the valve disc 350 can be raised and the basin filled with wash buffer sufficient to immerse the lower rotors 310, 320. The lower rotors can be rotated within the wash buffer to create an immediate flow of fluid over the slide substrates as the clamp rotor is separated from the carrier rotor, breaking open the sealed chambers covering the reaction areas. The wash cycle for the slide substrates received into the lower carrier rotor can continue as described previously.

In another aspect of the embodiment 300 of FIGS. 15 and 16, the method can further include bringing the clamp rotor 320 and carrier rotor 310 back together after the wash cycle is complete to re-establish the reaction chambers. The valve disc 350 can be lowered and the valve pins 366 re-inserted into the mixer/manifolds, and a variety of fluidic steps, such as nucleic acid denaturation and recovery, can be performed on the hybridized and washed microarray slides.

It can be appreciated that the valve station 360 can provide additional flexibility in processing and washing the slide substrate after hybridization. After incubation is complete, for instance, the valve pins 366 plugging the inlet/vent holes 340 can be partially opened by the pneumatic pistons 372 and elution buffer slowly pumped into the reaction chambers to wash the reaction areas and displace the hybridization fluid, which can be pushed out through the vent passages and collected with an appropriate collection device positioned below the vent outlets. The valve pins can then be re-lowered to seal the reaction chambers, and the slide substrate and mixer (e.g. the hybridization unit) reheated. Upon completion of the second processing step, the valve pins can be re-opened and additional heated elution buffer pumped through the reaction chambers to force the reacted fluid into another collection device.

Furthermore, in the case of the non-rotating processing device, after hybridization is complete the valve pins 366 plugging the inlet holes 340 can be partially opened and wash fluid pumped into the reaction chamber with enough pressure to push up the clamp fixture, break the mixer seal, and separate the mixer from slide substrate. The outer wash chamber seal can remain intact to maintain the high volume wash chamber. After the washing sequence is complete, the wash fluid can be replaced by nitrogen gas, or humidified or ozone-free air to remove any residual wash fluid from the slide.

In both the rotating and non-rotating embodiments of the processing device, the use of valve pins 366 (see FIGS. 15 and 16) can provide significant benefits over the prior art. For instance, the valve pins and valve stations 360 can be simple to fabricate with minimal moving parts, reducing the manufacturing costs of the processing device. Using valve pins to seal the filled reaction chambers for incubation is also less expensive than present conventional sealing methods, such as manually-applied tape. Solid, metallic valve pins can provide more reliable sealing with repeated use, as the softer contact surfaces of the disposable manifold's funnel-shaped openings 342 to the inlet holes 340 become the wear point, and are continuously replaced. Most significantly, however, the valve pin and manifold system can reduce the “dead” volume between the inlet and vent ports of the reaction chamber and the tip of the pin valves to a very small amount, in the range of 1-3 μl, thereby conserving the quantity of hybridization fluid needed to perform the test.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed is:

1. A hybridization unit for providing a hybridization reaction chamber on a microarray slide comprising:
a microarray slide substrate having a reaction area containing immobilized reactants;
a disposable shell removably coupled to the slide substrate to form a sealed reaction chamber enclosing the reaction area;
a first set of shell borders extending beyond a first pair of parallel edges of the slide substrate, for coupling the shell to a clamp fixture of a processing device;
a second set of shell borders exposing a second pair of parallel edges, for coupling the slide substrate to a carrier fixture of the processing device; and
wherein separation of the clamp fixture from the carrier fixture removes the shell from the slide substrate to open the sealed reaction chamber.

2. The hybridization unit of claim 1, wherein the first pair of shell borders and substrate edges are parallel to a short axis of the slide substrate, and the second pair of shell borders and substrate edges are parallel to a long axis of the slide substrate.

3. The hybridization unit of claim 1, wherein the first pair of shell borders and substrate edges are parallel to a long axis of the slide substrate, and the second pair of shell borders and substrate edges are parallel to a short axis of the slide substrate.

4. A system for the substantially automated hybridization of a plurality of microarray slides comprising:
a basin enclosure;
a slide carrier rotor disposed on a support axle within the basin enclosure, for receiving at least one microarray slide substrate therein;
a clamp rotor disposed on the support axle and adjacent the carrier rotor, for receiving at least one disposable shell therein;
wherein engaging the clamp rotor with the carrier rotor couples the shell to the slide substrate to form at least one sealed reaction chamber; and
wherein disengaging the clamp rotor from the carrier rotor de-couples the shell from the slide substrate to unseal the at least one reaction chamber.

5. The system of claim 4, further comprising at least one manifold coupled to the exposed surface of the at least one disposable shell, wherein the manifold has at least one fill hole and at least one vent hole aligned with a fill port and a vent port in the disposable shell.

6. The system of claim 5, further comprising a valve rotor disposed on the support axle adjacent the clamp rotor and having at least one valve station with outwardly-projecting valve pins, wherein engaging the valve rotor with the clamp rotor causes the valve pins to removably plug the at least one fill hole and the at least one vent hole of the at least one manifold.

7. A method of processing a plurality of microarray slides comprising:
inserting a plurality of microarray slides into a processing device, each of the plurality of slides having a reaction area enclosed by a low-volume disposable shell to form a low-volume reaction chamber;
filling the reaction chambers with a low-volume of hybridization fluid to hybridize the reaction areas;
removing the disposable shells from the plurality of slides to expose the hybridized reaction areas;
washing the plurality of slides in a common bath of wash fluid;
removing the plurality of slides from the common bath of wash fluid.

8. The method of claim 7, wherein the processing device further comprises at least one rotor disc disposed within a basin enclosure configured for containing the common bath of wash fluid.

9. The method of claim 8, wherein washing the plurality of microarray slides further comprises submerging and rotating the at least one rotor disc in the common bath of wash fluid contained in the basin enclosure.

10. The method of claim 9, wherein removing the plurality of microarray slides from the wash fluid further comprises separating the at least one rotor disc from the common bath of wash fluid and spinning the rotor disc to throw off the wash fluid.

11. A method of in-situ processing of a microarray slide for the analysis of immobilized samples comprising:
obtaining a microarray slide substrate having a reaction area containing immobilized samples;
mounting the slide substrate into a processing device for automated processing,
the processing further comprising the steps of:
coupling a disposable shell to the slide substrate to form a low-volume reaction chamber enclosing the reaction area;
filling the reaction chamber with hybridization fluid to react with the immobilized samples;
sealing the reaction chamber to prevent contamination during incubation;
de-coupling the shell from the slide substrate to unseal the reaction chamber;
flushing the reaction area with a high volume of wash fluid to remove the hybridization fluid; and
removing the wash fluid from the slide substrate; and
disengaging the slide substrate from the processing device.

12. The method of claim 11, wherein the low-volume reaction chamber holds less than about 100 μl of fluid.

13. The method of claim 11, wherein the disposable shell further comprises an attached manifold having at least one fill hole and at least one vent hole aligned with a fill port and a vent port in the disposable shell to facilitate filling the reaction chamber with hybridization fluid.

14. The method of claim 13, wherein sealing the reaction chamber further comprises removably plugging the at least one fill hole and the at least one vent hole with a plurality of valve pins.

15. The method of claim 11, further comprising agitating the hybridization fluid by alternately inflating and deflating pneumatic bladders formed in the disposable shell portion of the reaction chamber.

16. The method of claim 11, further comprising heating the slide substrate to improve the reaction of the hybridization fluid with the immobilized samples.

17. The method of claim 11, wherein the high volume of wash fluid further comprises of at least about 0.1 liters of wash fluid.

18. The method of claim 11, wherein removing the wash fluid further comprises blowing the wash fluid off the slide substrate with a stream of compressed gas.

19. The method of claim 11, further comprising simultaneously processing at least two slide substrates in the processing device, wherein the at least two slide substrates are flushed in a common volume of wash fluid.

20. A method of in-situ processing of at least two microarray slides for the analysis of immobilized samples comprising:
obtaining at least two microarray slide substrates having a reaction area containing immobilized samples;
coupling a disposable shell to each slide substrate to form a low-volume reaction chamber enclosing the reaction area;
filling the reaction chambers with hybridization fluid to react with the immobilized samples;
mounting the at least two slide substrates into a processing device for automated processing, the processing further comprising the steps of:
sealing the reaction chamber to prevent contamination during incubation;
agitating the hybridization fluid during incubation by alternately inflating and deflating pneumatic bladders formed in the disposable shell portion of the reaction chamber;
de-coupling the shell from the slide substrate to unseal the reaction chamber;
flushing the at least two slide substrates with a common wash fluid to remove the hybridization fluids from the reaction areas; and
removing the wash fluid from the slide substrates; and
disengaging the at least two slide substrate from the processing device.

21. The method of claim 20, wherein the disposable shell further comprises an attached manifold having at least one fill hole and at least one vent hole aligned with a fill port and a vent port in the disposable shell to facilitate filling the reaction chamber with hybridization fluid.

22. The method of claim 21, wherein sealing the reaction chamber further comprises removably plugging the at least one fill hole and the at least one vent hole with a plurality of valve pins.
